(19) United States
(12) Patent Application Publication
(10) Pub. No.: US 2013/0151886 A1
(43) Pub. Date: Jun. 13, 2013

(54) COMPUTING DEVICE AND METHOD FOR SWITCHING PHYSICAL LINKS OF A SAS EXPANDER OF THE COMPUTING DEVICE

(71) Applicant: CHIH-HUANG WU, New Taipei (TW)

(72) Inventor: CHIH-HUANG WU, New Taipei (TW)

(21) Appl. No.: 13/678,582

(22) Filed: Nov. 16, 2012

(30) Foreign Application Priority Data
Dec. 9, 2011 (TW) 100145487

(51) Int. Cl. G06F 11/14

(52) U.S. Cl. 714/5.1; 714/E11.142

(57) ABSTRACT

A method switches physical links of a serial attached small computer system interface (SAS) expander of a computing device. If a physical link of the SAS expander is malfunctioning, configuration parameters of the malfunctioned physical link are stored to a storage system of the computing device, and a reserved physical link corresponding to the malfunctioned physical link is selected from firmware of the SAS expander. The method further modifies configuration parameters of the malfunction physical link, produces a new firmware according to the modified configuration parameters and the selected reserved physical link, and switches the malfunctioned physical link to the reserved physical link by writing the new firmware to the SAS expander.

### BACKGROUND

1. Technical Field

Embodiments of the present disclosure relate to serial attached small computer system interface (SAS) expander switching technology, and particularly to a computing device and method for switching physical links of a SAS expander using the computing device.

2. Description of Related Art

When a SAS expander of a computing device is damaged by static electricity or by an external connection device, physical links of the SAS expander may malfunction. Replacing the SAS expander may solve the problem, but information on the hard disk may be lost, and a lot of time may be wasted. Therefore, a more efficient method for solving the problem is desired.

### BRIEF DESCRIPTION OF THE DRAWINGS

FIG. 1 is a block diagram of one embodiment of a computing device including a switching system.

FIG. 2 is a block diagram of function modules of the switching system included in the computing device of FIG. 1

FIG. 3 is a flowchart of one embodiment of a method for automatically switching physical links of a SAS expander using the computing device of the FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of non-transitory computer-readable medium include CDs, DVDs, BLU-RAY, flash memory, and hard disk drives.

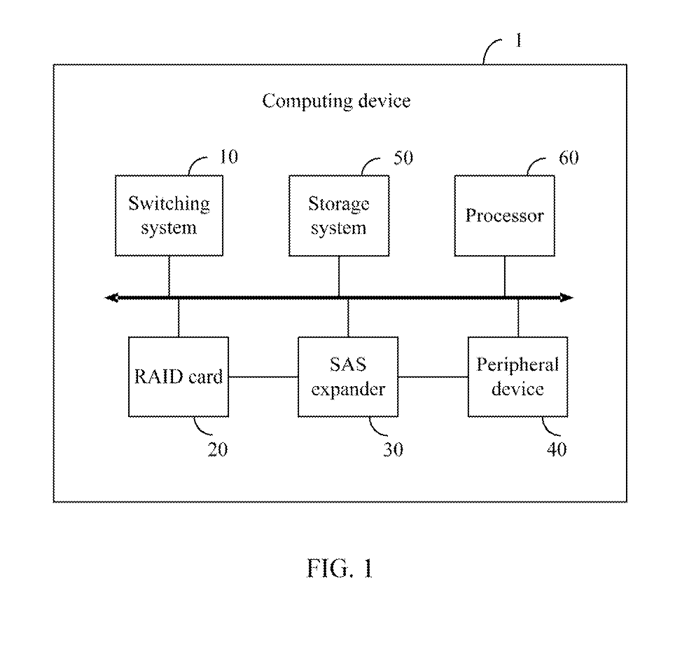

FIG. 1 is a block diagram of one embodiment of a computing device 1 including a switching system 10. In the embodiment, the computing device 1 further includes a redundant array of independent disks (RAID) card 20, a serial attached small computer system interface (SAS) expander 30, one or more peripheral devices 40 (only one shown in FIG. 1), a storage system 50, and at least one processor 60. The at least one processor 60 executes one or more computerized codes and other applications of the computing device 1, to provide functions of the switching system 10. The switching system 10 may determine whether one or more physical links of the SAS expander 30 are malfunctioning or not, and automatically switch the physical links that are malfunctioning to one or more reserved physical links.

The RAID card 20 may be electronically connected to the SAS expander 30 through a SAS port (not shown in FIG. 1). The SAS expander 30 may be electronically connected to one or more peripheral devices 40, such as, a hard disk drive (HDD), another SAS expander 30, and a SAS host bus adapter (HBA), for example. If the peripheral device 40 is the SAS expander 30, the peripheral device 40 may be electronically connected to other attached peripheral devices.

The storage system 50 stores data of the computing device 1. The storage system 50 may be an internal storage system, such as a random access memory (RAM) for temporary storage of information, and/or a read-only memory (ROM) for permanent storage of information. In some embodiments, the storage system 50 may also be an external storage system, such as an external hard disk, a storage card, or a data storage medium.

In one embodiment, the physical links are a set of four wires used as two differential signal pairs. One differential signal transmits in one direction, while the other differential signal transmits in the opposite direction. Data can be transmitted in both directions simultaneously. The physical links are contained in SAS ports which contain one or more working physical links and reserved physical links. Each of the physical links has an identification number. The SAS expander 30 may use the reserved physical links when the working physical links are malfunctioning. Each of the working physical links corresponds to one or more reserved physical links. The working physical links and the reserved physical links correspond to the working physical links are defined by hardware circuit of the SAS expander 30, and stored in the firmware of the SAS expander 30.

The SAS expander 30 includes a flash memory (not shown in FIG. 1) to store a firmware of the SAS expander 30. The firmware is embedded in the SAS expander 30 and makes functions of the SAS expander 30 work normally, and the firmware can be updated or upgraded. The firmware may accommodate, but is not limited to, configuration parameters of the SAS expander 30, such as, configuration data of the physical links of the SAS expander 30, address data of the SAS expander 30, and connection data of the physical links of the SAS expander 30, for example. The storage system 50 stores a file having an original firmware of the SAS expander 30 of the computing device 1, where the original firmware controls the SAS expander 30 to work normally.

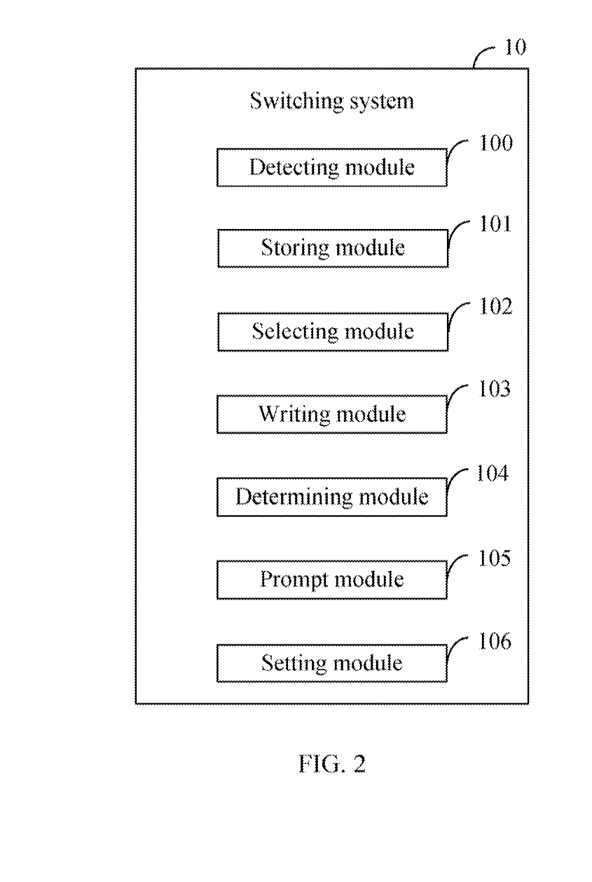

FIG. 2 is a block diagram of function modules of the switching system 10 included in the computing device 1 of FIG. 1. In the embodiment, the switching system 10 may include one or more modules, for example, a detecting module 100, a storing module 101, a selecting module 102, a writing module 103, a determining module 104, a prompt module 105 and a setting module 106. The one or more modules 100-106 may comprise computerized code in the form of one or more programs that are stored in the storage system 50 of the computing device 1. The computerized code includes instructions that are executed by the at least one processor 60 to provide functions for the one or more modules 100-106. A detailed description of each module will be given in the following paragraphs.

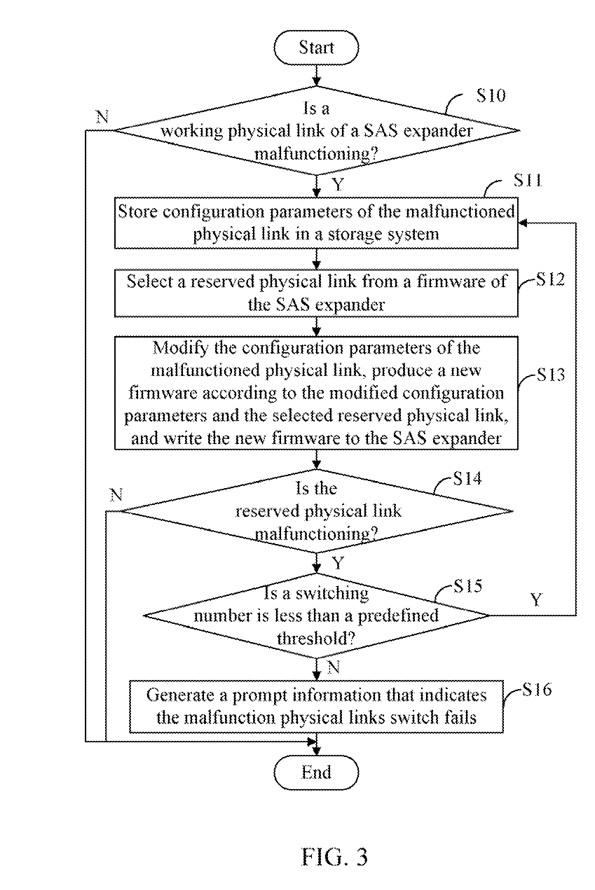

FIG. 3 is a flowchart of one embodiment of a method for automatically switching physical links of the SAS expander 30 using the computing device 1. Depending on the embodiment, additional steps may be added, others removed, and the ordering of the steps may be changed.

In step S10, the detecting module 100 detects whether a working physical link of the SAS expander 30 is malfunctioning. In some embodiments, if the connectivity of the SAS expander 30 and the peripheral device 40 works normally, the detecting module 100 determines that the working physical link of the SAS expander 30 is not malfunctioning, and the procedure ends. If the connectivity of the SAS expander 30 and the peripheral device 40 does not work normally, the detecting module 100 determines that the working physical link of the SAS expander 30 is malfunctioning, and step S11 is implemented. Hereinafter, the working physical links of the SAS expander 30 that is malfunctioning are referred as the malfunction physical links.

In one embodiment, the detecting module 100 determines whether the peripheral device 40 can be accessed by a default path. In the embodiment, the default path is set according to the hardware circuit of the SAS expander 30. If the peripheral device 40 can be accessed by the default path, the detecting module 100 determines that the connectivity of the SAS expander 30 and the peripheral device 40 works normally. If the peripheral device 40 cannot be accessed by the default path, the detecting module 100 determines that the connectivity of the SAS expander 30 and the peripheral device 40 does not work normally.

In one embodiment, the detecting module 100 determines whether the peripheral device 40 generates a feedback signal corresponding to a detection signal after the SAS expander 30 sends the detection signal to the peripheral device 40. If the peripheral device 40 generates the feedback signal, the detecting module 100 determines the connectivity of the SAS expander 30 and the peripheral device 40 works normally. If the peripheral device 40 does not generate the feedback signal, the detecting module 100 determines the connectivity of the SAS expander 30 and the peripheral device 40 does not work normally.

In step S11, the storing module 101 stores configuration parameters of the malfunction physical link to the storage system 50. The configuration parameters are obtained from the firmware of the SAS expander 30, and include configuration data of the malfunction physical link, address data of the SAS expander 30, and connection data of the malfunction physical link, for example.

In step S12, the selecting module 102 selects a reserved physical link corresponding to the malfunction physical link from the firmware of the SAS expander 30. In one embodiment, the setting module 106 may set a sequence for selecting the reserved physical link from the one or more reserved physical links, where the sequence may be user-determined or pre-determined. If only one reserved physical link exists in the SAS expander 30, the reserved physical link is always selected. If more than one reserved physical links exist in the SAS expander 30, the sequence may be in an arbitrary order for selecting one of the reserved physical links. For example, if the SAS expander 30 has two reserved physical links with the identification number 21 and 22, the selecting module 102 may firstly select the reserved physical link having the identification number 21, and then selects the reserved physical link having the identification number 22.

In step S13, the writing module 103 modifies the stored configuration parameters of the malfunction physical link, produces a new firmware according to the modified configuration parameters and the selected reserved physical link, and switches the malfunction physical link to the reserved physical link by writing the new firmware to the SAS expander 30. The new firmware includes the modified configuration parameters, the original firmware of the SAS expander 30 of the firmware file and the identification number of the selected reserved physical link.

The SAS expander 30 can only store one firmware. In one embodiment, after the new firmware is written into the SAS expander 30, the firmware stored in the SAS expander 30 is replaced by the new firmware, and the SAS expander 30 uses the selected reserved physical link. After the new firmware is written into the SAS expander 30, switching between the malfunction physical link and the reserved physical link is finished, and a switching number is increased by one, where the switching number is initialized as zero.

In step S14, the detecting module 100 detects whether the selected reserved physical link is malfunctioning. If the selected reserved physical link is not malfunctioning, the procedure ends. If the selected reserved physical link is malfunctioning, step S15 is implemented. The method of detecting whether the selected reserved physical link is malfunctioning is the same as that of step S10.

In step S15, the determining module 104 determines whether the switching number is less than a predefined threshold. If the switching number is less than the predefined threshold, step S11 is repeated. If the switching number is not less than the predefined threshold, step S16 is implemented.

The predefined threshold may be user-determined or pre-determined, and is an integer (e.g. 2 or 3) to define the switching number that the malfunction physical links can switch to the reserved physical links. In one embodiment, if the predefined threshold is 2, after the malfunction physical link switch to the reserved physical link, and the reserved physical link is malfunctioning, then the reserved physical link may switch to another reserved physical link, where the another reserved physical link is set by the setting module 106.

In step S16, the prompt module 105 generates a prompt information that indicates the malfunction physical links switch fails. The prompt information may include the switching number, failure reasons, the reserved physical links, and the configuration parameters of the malfunction physical links, for example.

In the prior art, if the physical links of the SAS expander 30 are malfunctioning, the SAS expander 30 is always replaced with a new SAS expander. This replacement may lead to information on the hard disk being lost, and also time consuming. In this disclosure, when the physical links of the SAS expander 30 are malfunctioning, the malfunction physical links can switch to the reserved physical links automatically. Thus, the SAS expander 30 is not replaced with a new SAS expander to avoid the information on the hard disk being lost and time consuming.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computerized-implemented method for switching physical links of a serial attached small computer system interface (SAS) expander of a computing device, the method comprising:
(a) detecting whether one of the physical links of the SAS expander is malfunctioning;
(b) when one of the physical links of the SAS expander is malfunctioning, storing configuration parameters of the malfunctioned physical link in a storage system of the computing device;
(c) selecting a reserved physical link corresponding to the malfunctioned physical link from firmware of the SAS expander;
(d) modifying configuration parameters of the malfunction physical link, producing a new firmware according to the modified configuration parameters and the selected reserved physical link; and
(e) switching the malfunctioned physical link to the reserved physical link by writing the new firmware to the SAS expander.

2. The method according to claim 1, further comprising:
increasing by one to a switching number after the malfunctioned physical link is switched to the reserved physical link.

3. The method according to claim 2, after step (e) further comprising:
detecting whether the reserved physical link is malfunctioning;
determining whether the switching number is less than a predefined threshold when the reserved physical link is malfunctioning;
storing the malfunctioned reserved physical link to the storage system when the switching number is less than the predefined threshold; and
generating a prompt information indicating that the malfunctioned physical link switches fails when the switching number is not less than the threshold.

4. The method according to claim 1, wherein step (a) comprises:
determining that the physical links of the SAS expander are not malfunctioning when the connectivity of the SAS expander and a peripheral device connected to the SAS expander works normally; and
determining that the physical links of the SAS expander are malfunctioning when the connectivity of the SAS expander and the peripheral device does not work normally.

5. The method according to claim 4, wherein detecting whether the connectivity of the SAS expander and the peripheral device works normally by:
determining whether the peripheral device is accessed by a default path; or
determining whether the peripheral device generates a feedback signal after the SAS expander sends a detection signal to the peripheral device.

6. The method according to claim 1, wherein step (c) comprises:
setting a sequence for selecting the reserved physical link from one or more reserved physical links;
selecting the reserved physical link if only one reserved physical link exists in the SAS expander; and
selecting one of the reserved physical links in the sequence with an arbitrary order if more than one reserved physical links exist in the SAS expander.

7. A computing device, comprising:
a serial attached small computer system interface (SAS) expander;
a storage system;
at least one processor; and
one or more modules that are stored in the storage system and are executed by the at least one processor, the one or more modules comprising instructions to:
detect whether one of the physical links of the SAS expander is malfunctioning;
when the one of the physical links of the SAS expander is malfunctioning, store configuration parameters of the malfunctioned physical link in the storage system;
select a reserved physical link corresponding to the malfunctioned physical link from firmware of the SAS expander;
modify configuration parameters of the malfunction physical link, and produce a new firmware according to the modified configuration parameters and the selected reserved physical link; and
switch the malfunctioned physical link to the reserved physical link by writing the new firmware to the SAS expander.

8. The computing device according to claim 7, the one or more modules further comprise instructions to:
increase by one to a switching number after the malfunctioned physical link is switched to the reserved physical link.

9. The computing device according to claim 8, the one or more modules further comprise instructions to:
detect whether the reserved physical links is malfunctioning;
determine whether the switching number is less than a predefined threshold when the reserved physical link is malfunctioning;
store the malfunctioned reserved physical link to the storage system when the switching number is less than the predefined threshold; and
generate a prompt information indicating that the malfunctioned physical link switches in fails when the switching number is not less than the predefined threshold.

10. The computing device according to claim 7, wherein the one or more modules further comprise instructions to:
determine that the physical links of the SAS expander are not malfunctioning when the connectivity of the SAS expander and a peripheral device connected to the SAS expander works normally; and
determine that the physical links of the SAS expander are malfunctioning when the connectivity of the SAS expander and the peripheral device does not work normally.

11. The computing device according to claim 10, wherein detecting whether the connectivity of the SAS expander and the peripheral device works normally by:
determining whether the peripheral device is accessed by a default path; or
determining whether the peripheral device generates a feedback signal after the SAS expander sends a detection signal to the peripheral device.

12. The computing device according to claim 7, wherein the one or more modules further comprise instructions to:
set a sequence for selecting the reserved physical link from one or more reserved physical links;
select the reserved physical link if only one reserved physical link exists in the SAS expander; and
select one of the reserved physical links in the sequence with an arbitrary order if more than one reserved physical links exist in the SAS expander.

13. A non-transitory storage medium having stored thereon instructions that, when executed by a processor of a computing device, causes the computing device to perform a method for switching physical links of a serial attached small computer system interface (SAS) expander of the computing device, the method comprising:
(a) detecting whether one of the physical links of the SAS expander is malfunctioning;
(b) when one of the physical links of the SAS expander is malfunctioning, storing configuration parameters of the malfunctioned physical link in a storage system of the computing device;
(c) selecting a reserved physical link corresponding to the malfunctioned physical link from firmware of the SAS expander;
(d) modifying configuration parameters of the malfunction physical link, producing a new firmware according to the modified configuration parameters and the selected reserved physical link; and
(e) switching the malfunctioned physical link to the reserved physical link by writing the new firmware to the SAS expander.

14. The non-transitory storage medium according to claim 13, wherein the method further comprises:
increasing by one to a switching number after the malfunctioned physical link is switched to the reserved physical link.

15. The non-transitory storage medium according to claim 14, after step (e) the method further comprises:
detecting whether the reserved physical link is malfunctioning;
determining whether the switching number is less than a predefined threshold when the reserved physical link is malfunctioning;
storing the malfunctioned reserved physical link to the storage system when the switching number is less than the predefined threshold; and
generating a prompt information indicating that the malfunctioned physical link switches fails when the switching number is not less than the threshold.

16. The non-transitory storage medium according to claim 13, wherein step (a) comprises:
determining that the physical links of the SAS expander are not malfunctioning when the connectivity of the SAS expander and a peripheral device connected to the SAS expander works normally; and
determining that the physical links of the SAS expander are malfunctioning when the connectivity of the SAS expander and the peripheral device does not work normally.

17. The non-transitory storage medium according to claim 16, wherein detecting whether the connectivity of the SAS expander and the peripheral device works normally by:
determining whether the peripheral device is accessed by a default path; or
determining whether the peripheral device generates a feedback signal after the SAS expander sends a detection signal to the peripheral device.

18. The non-transitory storage medium according to claim 13, wherein step (c) comprises:
setting a sequence for selecting the reserved physical link from one or more reserved physical links;
selecting the reserved physical link if only one reserved physical link exists in the SAS expander; and
selecting one of the reserved physical links in the sequence with an arbitrary order if more than one reserved physical links exist in the SAS expander.
